(19) United States
(12) Patent Application Publication
(10) Pub. No.: US 2024/0245035 A1
(43) Pub. Date: Jul. 25, 2024

(54) HORSE LEG HOLDER SLING

(71) Applicant: Leo Christopher McNamara, Queensland (AU)

(72) Inventor: Leo Christopher McNamara, Queensland (AU)

(21) Appl. No.: 18/121,071

(22) Filed: Mar. 14, 2023

(30) Foreign Application Priority Data
Jan. 19, 2023 (AU) 2023200291

(51) Int. Cl. A01K 13/00

(52) U.S. Cl. CPC A01K 13/007

(57) ABSTRACT

The preferred embodiment of the present invention is a sling for holding a leg of an animal and a method of use thereof, the sling having a strap portion wrapable around the animal's leg; and two anchor portions spaced apart by the strap portion, wherein in use the strap portion is wrapped around the raised leg of the animal, while the anchor portions are positioned between a person's legs to support the animal's leg in the raised position so that the foot of the raised animal's leg can be treated and/or shoed.

### CROSS REFERENCE TO RELATED APPLICATION

This application claims the priority filing benefit of Australian Patent Application No. 2023200291 filed on Jan. 19, 2023, which is incorporated herein by reference in its entirety.

### FIELD OF INVENTION

The present invention relates to a sling for holding a leg of an animal. The present invention has particular but not exclusive application for holding a leg of a horse. In the patent specification, the sling will be described with reference to use with a horse, but this is by way of example only and the invention is not limited to this example.

### BACKGROUND OF THE INVENTION

Horses, ponies, donkeys and mules often require work to be shoed, groomed, and be treated for injuries or disease. Shoeing a horse requires a handler, such as a farrier or veterinarian, to treat a foot while the horse is awake and standing.

The horse's leg is held in a raised position for shoeing, grooming and/or treatment. Holding the horse's leg in a raised position for a prolonged period of time can be uncomfortable and tiring for the horse and the handler. Further, the handler, must maintain control over the horse's leg in a raised position in order to work on the horse's leg.

Control over the horse with a raised leg is dependent on the strength, dexterity, stamina, and experience of the handler and the strength, size, and temperament of the horse. Normally, the handler must control the raised leg with one hand leaving them with only one hand to work on the horse's leg or hoof.

The horse may also resist being worked on and can move unexpectedly. For example, when a horse loses its footing, it moves to regain its balance. This movement and uneasiness can cause injury to the handler and/or the horse.

It is a standard practice for such work to be performed while holding the horse leg between the legs of the handler. However, the handler is at risk of injury if the horse moves suddenly and unexpectedly while the horse's leg is positioned between the handler's legs.

### OBJECT OF THE INVENTION

It is an object of the present invention to alleviate at least in part one or more of the aforementioned problems or at least provide a viable alternative.

### SUMMARY OF THE INVENTION

The inventor of the present invention considered that current practices for holding a horse's leg in a raised position for shoeing, grooming and/or treatment was problematic because the handler can only use one hand for working purposes and they are exposed to risk of injury should the horse make a sudden and unexpected movement. This problem is exacerbated when working with old and/or arthritic horses or if the handler was weak, disabled, or old.

The inventor subsequently developed a sling that wraps around the horse's leg and provides comfort and support to the horse. The sling allows the handler to control the animal's leg by gripping the sling between the handler's legs and thus allowing the handler to use both of their hands.

In one aspect the present invention broadly resides in a sling for holding a leg of an animal, the sling having
a strap portion wrapable around the animal's leg; and
two anchor portions spaced apart by the strap portion,
wherein in use the strap portion is wrapped around the raised leg of the animal, while the anchor portions are positioned between a person's legs to support the animal's leg in the raised position so that the foot of the raised animal's leg can be treated and/or shoed.

Preferably, the sling is elongate.

In one preferred embodiment, at least one of the anchor portions and the strap portion are elongate, and the at least one of the anchor portions has a greater thickness than the strap portion.

Preferably, each anchor portion is elongate and has a greater width than the strap portion.

Preferably, each anchor portion is shaped so that they can be positioned between a person's knees or their upper legs, to support the animal's leg in the raised position.

Preferably, at least one of the anchor portions is cushioned. More preferably, each anchor portion is cushioned. In one preferred embodiment, each anchor portion has a foam cushion.

In one preferred embodiment, each anchor portion is shaped so that when the anchor portions are positioned between the person's legs, the anchor portions abut each other.

In one preferred embodiment, each anchor portion has at least one flat side, and when the anchor portions are positioned between the person's legs, the at least one flat side of each anchor portion abut each other.

In one preferred embodiment, at least one of the anchor portions has a tapered section. More preferably, both anchor portions have a tapered section adjacent the strap portion. In one embodiment, each anchor portion has a tapered section adjacent the strap portion. The tapered sections are preferably narrow near the strap portion.

When the anchor portions are positioned between the person's legs and abut each other, the tapered section of each anchor portion defines a substantially V-shaped recess. Preferably, when the abutting anchor portions are held between the person's legs and the animal's leg then moves towards the abutting anchor portions, the animal's leg is received within the substantially V-shaped recess and the anchor portions provide a cushioning effect.

In one embodiment, the sling has a durable fabric outer surface.

In one embodiment, an outer surface of each tapered section is covered in a wear-resistant material. Preferably, the outer surface of each tapered section is covered in leather.

Preferably, the strap portion is twistable. More preferably, the strap portion is twistable so that when the strap portion is wrapped around the animal's leg, the strap portion can be twisted to secure the strap portion to the animal's leg.

Preferably, the strap portion is wrapable around a lower portion of the animal's leg. In one embodiment, the strap portion is wrapable around an ankle of the animal's leg. In another embodiment, the strap portion is wrapable around a fetlock of the animal's leg. In one preferred embodiment where the animal is a horse, the strap portion is wrapable around a pastern of the animal's leg. In one preferred embodiment, the strap portion is wrapable between the hoof and fetlock of the animal so that the hoof and fetlock restrict movement of the sling along the animal's leg. Preferably, the width of the strap portion is less than the length of the pastern so that the hoof and fetlock restricts movement of the sling along the animal's leg.

With respect to a horse, the strap preferably has an anchor portion length of between 20 cm to 30 cm, an anchor portion width of between 2 cm to 12 cm, an anchor portion thickness of between 2 cm to 10 cm, a tapered section length of between 4 cm to 8 cm, a strap portion length of between 20 cm to 30 cm, and a strap portion width of between 1 cm to 5 cm.

With respect to a horse, the strap preferably has anchor portion length of 25 cm, an anchor portion width of 8 cm, an anchor portion thickness of 5 cm, a tapered section length of 6 cm, a strap portion length of 25 cm, and a strap portion width of 2 cm.

The dimensions of the sling are preferably selected so that the sling is suitable for use to hold a leg of a horse, pony, donkey or mule.

In one preferred embodiment, the sling has at least one hanging strap, hook or loop located at an end of the sling for use to store the sling when the sling is not in use.

In another aspect, the invention broadly resides in a sling for holding a leg of an animal, the sling having
a strap portion adapted to wrap around the animal's leg; and
two anchor portions spaced apart by the strap portion,
   wherein in use the strap portion is wrapped around the raised leg of the animal and twisted to secure the strap portion to the animal's leg, while the anchor portions are positioned between a person's legs to support the animal's leg in the raised position so that the foot of the raised animal's leg can be treated and/or shoed.

Preferably each anchor portion has a tapered section adjacent the strap portion and each tapered section narrows towards the strap portion.

Preferably each anchor portion is shaped so that when the anchor portions are positioned between the person's legs, the anchor portions abut each other.

Preferably each anchor portion has a tapered section adjacent the strap portion, and when the anchor portions are positioned between the person's legs and abut each other the tapered section of each anchor portion defines a substantially V-shaped recess.

Preferably each anchor portion has at least one flat side, and when the anchor portions are positioned between the person's legs, the at least one flat side of each anchor portion abut each other.

Preferably at least one of the anchor portions and the strap portion are elongate, and the at least one of the anchor portions has a greater thickness than the strap portion.

Preferably at least one of the anchor portions is cushioned.

Preferably the strap portion is adapted to wrap around a pastern of the animal's leg and the width of the strap portion is less than the length of the pastern so that the hoof and fetlock restricts movement of the sling along the animal's leg.

Preferably the strap portion has a length between 20 cm to 30 cm, and the strap portion has a width between 1 cm to 5 cm and the sling has at least one hook or loop located at an end of the sling.

Preferably each anchor portion is elongate and has a greater width than the strap portion.

Preferably each anchor portion has a length between 20 cm to 30 cm, each anchor portion has a width between 2 cm to 12 cm, each anchor portion has a thickness between 2 cm to 10 cm.

In a further aspect the present invention broadly resides in a method for holding an animal's leg in a raised position with a sling, the sling having
a strap portion wrapable around the animal's leg; and
two anchor portions spaced apart by the strap portion,
the method having the steps of
raising the leg of the animal into the raised position;
wrapping the strap portion around the animal's leg; and
positioning and holding the two anchor portions between a person's legs to support the animal's leg in the raised position.

Preferably, the person stands to the side of the animal's leg so that the animal's leg in the raised position is not positioned between the person's legs.

Preferably, the method includes, the step of, twisting the strap portion to hold the strap portion to the animal's leg so that the animal's leg is secured to the sling.

When the animal's leg is held in the raised position, the person can shoe, groom and/or treat the animal's leg.

In a further aspect the present invention broadly resides in a method for treating an animal's leg by holding the animal's leg in a raised position with a sling, the sling having
a strap portion wrapable around the animal's leg; and
two anchor portions spaced apart by the strap portion,
the method having the steps of
raising the leg of the animal into the raised position;
wrapping the strap portion around the animal's leg; and
positioning and holding the two anchor portions between a person's legs to support the animal's leg in the raised position so that the foot of the raised leg can be treated; and
treating the animal's leg.

The features described with respect to one aspect also apply where applicable to all other aspects of the invention. Furthermore, different combinations of described features are herein described and claimed even when not expressly stated.

### BRIEF DESCRIPTION OF THE DRAWINGS

In order that the present invention can be more readily understood reference will now be made to the accompanying drawings which illustrate a preferred embodiment of the invention and wherein:

FIG. 1 is a plan view of a sling according to a preferred embodiment of the present invention;

FIG. 2 is a perspective view of the sling of FIG. 1 being wrapped around a horse's leg;

FIG. 3 is a perspective view of the sling of FIG. 1 being twisted to secure a horse's leg; and

FIG. 4 is a perspective view of the sling of FIG. 1 wrapped around a horse's leg and positioned between the legs of a person.

### DETAILED DESCRIPTION OF THE PREFERRED EMBODIMENT

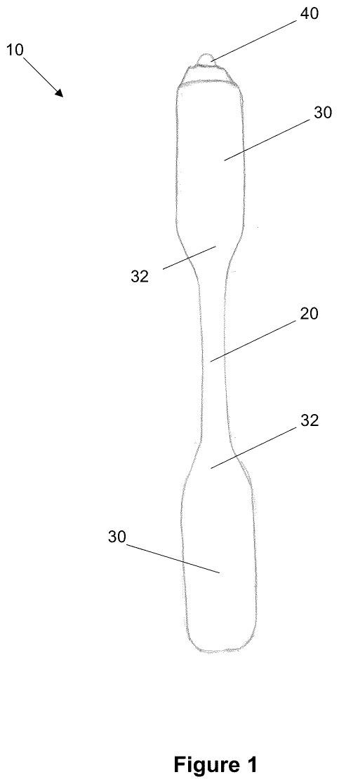

Referring to FIG. 1, there is shown a preferred embodiment of an elongate sling 10. The sling 10 has an elongate strap portion 20 intermediate between two elongate anchor portions 30.

The strap portion 20 has a width less than the length of the pastern 82 of the horse's leg 80. This allows the strap portion 20 to be wrapped around the pastern 82 securely between the horse's hoof and fetlock, wherein the hoof and fetlock restricts the movement of the sling along the horse's leg 80.

The anchor portions 30 have a greater width than the width of the strap portion 20. The anchor portions 30 have a greater thickness than the thickness of the strap portion 20. Each anchor portion 30 has a substantially rectangular foam cushion.

The anchor portions 30 are substantially wide, thick and cushioned to assist in suitably holding the anchor portions 30 between the legs of a person comfortably. In particular, the anchor portions 30 are substantially thick to suitably maintain the person's legs 90 at a comfortable distance to one another and maintain the person in a stable stance when the person is holding and squeezing the anchor portions 30 between their legs.

The cushioning allows the anchor portions 30 to deform when squeezed by the person's legs 90 and restrict lateral movement that could pull the anchor portions 30 from between the person's legs 90.

Each anchor portion 30 has a flat side. The flat side of one anchor portion 30 conforms with the flat side of the other anchor portion 30 so that when the anchor portions 30 are held together the flat side of each anchor portions 30 abut.

Each anchor portion 30 has a tapered section 32 adjacent the strap portion 20. Each tapered section 32 is narrow near the strap portion 20. The tapered section 32A is covered in leather. Each foam cushion extends into each tapered section 32A.

The sling 10 has a durable fabric outer surface which forms the strap portion 20 and covers two elongate anchor portions 30. The strap portion 20 is twistable.

The sling 10 has a hanging loop 40 positioned on an end thereof. The sling 10 can be hung by the hanging loop 40 upon a hook when not in use.

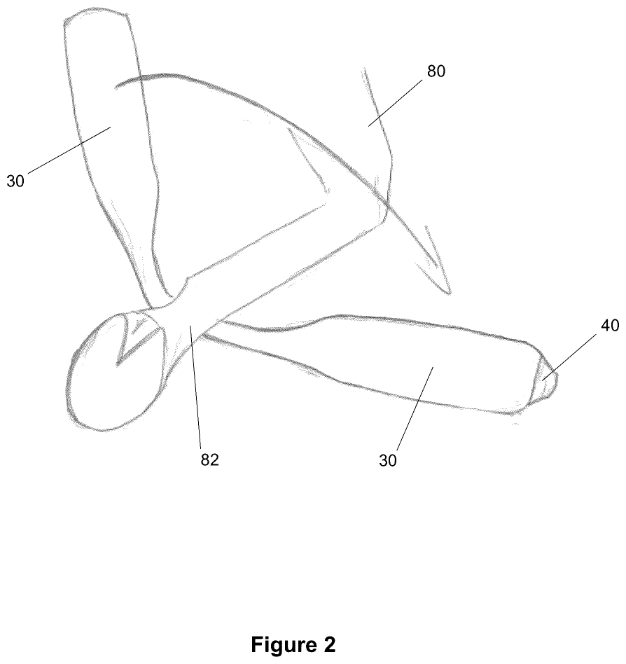

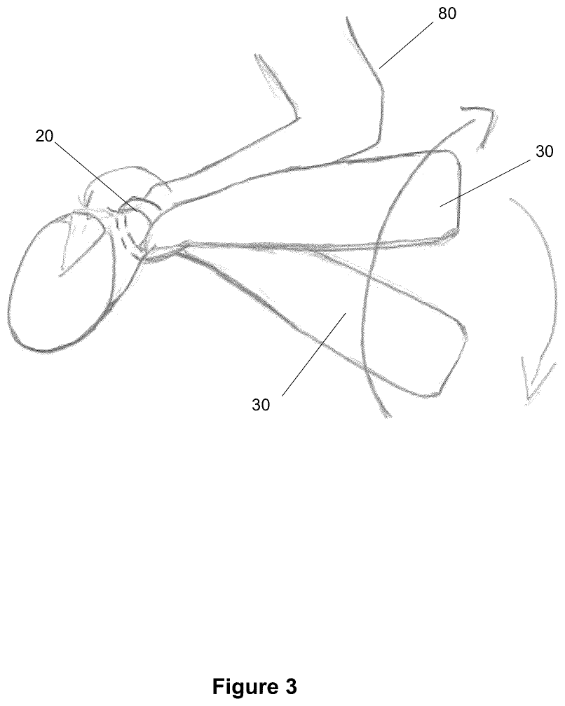

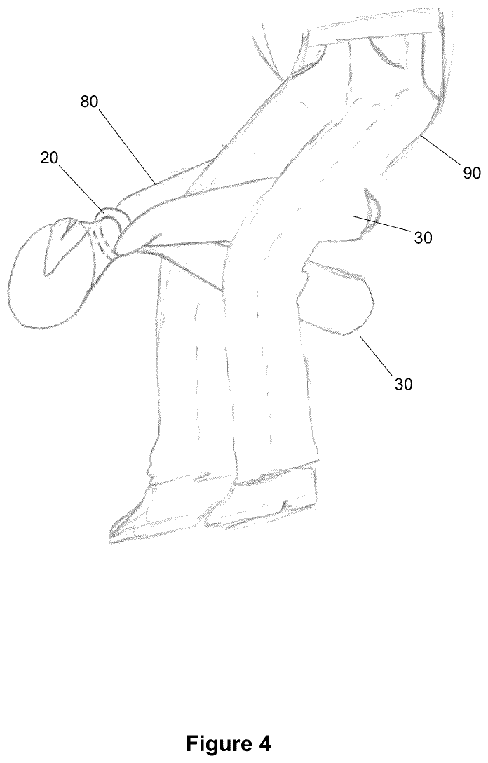

Referring to the FIGS. 2 to 4, there is shown the sling 10 for holding a horse's leg 80 in a raised position with the sling 10.

The horse's leg 80 is raised into a raised position.

The strap portion 20 is wrapped around the pastern 82 of the horse's leg 80 so that the anchor portions 30 end up on the same side of the horse's leg 80.

The anchor portions 30 are twisted so as to secure the sling 10 to the horse's leg 80.

A person stands to the side of the horse's leg 80 so that the horse's leg 80 in the raised position is not positioned between the person's legs 90. The anchor portions 30 are then placed between the person's legs 90. The anchor portions 30 can be placed between the knees or thighs of the person's legs 90. The person holds the anchor portions 30 in place by lightly squeezing their legs 90 together.

As the horse's leg 80 is not positioned between the person's legs the person's exposure to harm in the event of the horse moving suddenly and unexpectedly is reduced.

As the sling 10 is held by the person's legs 90 both hands are free to perform work tasks such as shoeing, grooming or treating the horse's hoof or lower leg.

The sling 10 can be repositioned so that the raised position can be adjusted for the comfort of the person or horse, or to suit the needs of the work to be performed.

The arrangement of the anchor portions 30 between the person's legs 90 can depend on the comfort of the position for the person, or whether the arrangement aids in having a secure hold of the horse's leg 80. The anchor portions 30 can be arranged such that each anchor portion 30 touches each of the person's legs 90.

Alternatively, the anchor portions 30 can be arranged such that the flat sides of the anchor portions 30 abut each other and each anchor portion 30 only touches one of the person's legs 90. This can allow the person to have a wider stance.

When the anchor portions 30 are positioned between the person's legs 90 the tapered sections 32 form a substantially V-shaped recess which narrows towards the person's legs 90. In the event that the horse's leg 80 moves towards the person's legs 90, the horse's leg 80 will first be received within the substantially V-shaped recess. The perimeter of the substantially V-shaped recess acts against the horse's leg 80 to resist movement of the horse's leg 80 towards the person's legs 90.

### Advantages

An advantage of the preferred embodiment of the present invention is that the sling allows the animal's leg to be held comfortably in the raised position for a prolonged period of time.

A further advantage of the preferred embodiment of the present invention is that in use both of the user's hands are free to be used to hold tools or instruments.

Another advantage of the preferred embodiment of the present invention is that the sling is comfortable for an animal to be held by, particularly for aged or arthritic animals.

A further advantage of the preferred embodiment of the present invention is that the sling is easy and comfortable for a person to use, particularly if the person is weak, less-dexterous, inexperienced in handling animals, old or arthritic.

Another advantage of the preferred embodiment of the present invention is that as the animal's leg is held outside of between the person's legs the risk that the person is harmed in the event of the animal moving suddenly and/or unexpectedly is reduced.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A sling for holding a leg of an animal, the sling comprising
a strap portion adapted to wrap around the animal's leg; and
two anchor portions spaced apart by the strap portion,
wherein in use the strap portion is wrapped around a raised leg of the animal and twisted to secure the strap portion to the animal's leg, while the anchor portions are positioned between a person's legs to support the animal's leg in a raised position so that a foot of the raised animal's leg can be treated and/or shoed.

2. The sling as claimed in claim 1, wherein each anchor portion has a tapered section adjacent the strap portion and each tapered section narrows towards the strap portion.

3. The sling as claimed in claim 1, wherein each anchor portion is shaped so that when the anchor portions are positioned between the person's legs, the anchor portions abut each other.

4. The sling as claimed in claim 1, wherein each anchor portion has a tapered section adjacent the strap portion, and when the anchor portions are positioned between the person's legs and abut each other the tapered section of each anchor portion defines a substantially V-shaped recess.

5. The sling as claimed in claim 1, wherein each anchor portion has at least one flat side, and when the anchor portions are positioned between the person's legs, the at least one flat side of each anchor portion abut each other.

6. The sling as claimed in claim 1, wherein at least one of the anchor portions and the strap portion are elongate, and the at least one of the anchor portions has a greater thickness than the strap portion.

7. The sling as claimed in claim 1, wherein at least one of the anchor portions is cushioned.

8. The sling as claimed in claim 1, wherein the strap portion is adapted to wrap around a pastern of the animal's leg and a width of the strap portion is less than a length of the pastern so that a hoof and fetlock restricts movement of the sling along the animal's leg.

9. The sling as claimed in claim 1, wherein the strap portion has a length between 20 cm to 30 cm, and the strap portion has a width between 1 cm to 5 cm and the sling has at least one hook or loop located at an end of the sling.

10. The sling as claimed in claim 1, wherein each anchor portion is elongate and has a greater width than the strap portion.

11. The sling as claimed in claim 1, wherein each anchor portion has a length between 20 cm to 30 cm, each anchor portion has a width between 2 cm to 12 cm, each anchor portion has a thickness between 2 cm to 10 cm.
